(19) United States
(12) Patent Application Publication
(10) Pub. No.: US 2021/0126452 A1
(43) Pub. Date: Apr. 29, 2021

(54) SYSTEMS AND METHODS FOR ASSESSING RELIABILITY OF ELECTRICAL POWER TRANSMISSION SYSTEMS

(71) Applicants: Anamitra Pal, Tempe, AZ (US); Meghna Barkakati, Canning Vale (AU)

(72) Inventors: Anamitra Pal, Tempe, AZ (US); Meghna Barkakati, Canning Vale (AU)

(73) Assignee: Arizona Board of Regents on behalf of Arizona State University, Scottsdale, AZ (US)

(21) Appl. No.: 17/078,863

(22) Filed: Oct. 23, 2020

Related U.S. Application Data
(60) Provisional application No. 62/925,976, filed on Oct. 25, 2019.

(51) Int. Cl. H02J 3/00

(52) U.S. Cl. CPC H02J 3/0012; G06Q 50/06; H02J 3/003; H02J 3/00125

(57) ABSTRACT

Systems and methods for assessing reliability of electrical power transmission systems are provided. Embodiments disclosed herein use Outage Impact Index (OII), a new reliability indicator, to identify periodic (e.g., annual) system risks in transmission systems of a bulk power system (BPS) for a given voltage class. OII provides key performance indices which can be used by power utilities to quantify and assess transmission system performance, establish baselines from chronological trends, and minimize system risks by developing corrective measures to address any identified system issues.

### RELATED APPLICATIONS

This application claims the benefit of provisional patent application Ser. No. 62/925,976, filed Oct. 25, 2019, the disclosure of which is hereby incorporated herein by reference in its entirety.

### FIELD OF THE DISCLOSURE

This application relates to reliability of electrical power transmission systems.

### BACKGROUND

According to the North American Electric Reliability Corporation (NERC), the definition of reliability of a system, such as an electrical power transmission system, is the ability of the system to withstand disturbances and meet consumer demands consistently. High reliability of the transmission system ensures secure transfer of uninterrupted power from generating sources to load centers and is thus of utmost importance to both utilities and consumers. Evaluation of reliability is also a crucial component during planning, design, operation, and maintenance of the power system. Furthermore, detailed analysis of system reliability may reveal vulnerable areas in the transmission network by establishing chronological system performance trends.

The power industry uses several reliability indices, such as system average interruption duration index (SAIDI), system average interruption frequency index (SAIFI), customer average interruption duration index (CAIDI), and customer average interruption frequency index (CAIFI), to quantify the reliability of distribution systems. However, these indices are not very relevant for quantifying the reliability of the transmission system because, due to system redundancy, customers are generally not directly impacted by a failure in the transmission system. For some of the system performance indices and reliability metrics proposed for the transmission system, the emphasis is on quantitative evaluation of transmission reliability using historical transmission line outage data and probability theory. As per the Institute of Electrical and Electronics Engineers (IEEE) Standard 859:1987, the outage indices used for transmission system performance evaluation are:

Rate Indices: outage and failure rate;

Duration Indices: mean time to outage and mean outage duration; and

State Probability Indices: availability and unavailability.

Additionally, IEEE Standard 493:1997 provides information on key performance indices used for power system reliability analysis such as mean time between failure (MTBF) and mean time to repair (MTTR). In 2008, the NERC approved the Transmission Availability Data System (TADS) to collect transmission equipment inventory and outage data. This data was used by NERC committees to analyze transmission line outages. In a 2013 paper (M. Papic, J. J. Bian, and S. Ekisheva, “A novel statistical-based analysis of WECC bulk transmission reliability data,” in Proc. IEEE Power Eng. Soc. Gen. Meeting, Vancouver, BC, Canada, pp. 1-5, Jul. 21-25, 2013.), a new statistical analysis model was proposed that considered the stochastic nature of outages and classified the variables into three groups, namely: categorical, indicator, and explanatory. A new index called severity factor was introduced in a 2016 paper (M. Faifer, M. Khalil, C. Laurano, G. Leone, and S. Toscani, “Outage data analysis and RAMS evaluation of the Italian overhead transmission lines,” in Proc. IEEE Int. Energy Conf. (ENERGYCON 2016), Leuven, Belgium, pp. 1-6, Apr. 4-8, 2016.) to prioritize failure causes over the entire study period by using outage frequency and duration metrics. However, this metric was not found to be useful during evaluation of outage severity on an annual basis, as will be demonstrated below.

Another widely used transmission reliability index in the electric power industry is forced outage per hundred miles per year (FOHMY). FOHMY is an average annual ratio which relates the number of forced outages to the circuit mileage of the line, and is given by:

FOHMY=Total Outage Frequency/Circuit Miles*100 Equation 1

It is well known that both frequency and duration of transmission line outages have significant impacts on operation and reliability of the power system. However, from Equation 1, it is observed that FOHMY does not consider outage duration. This was also confirmed in an analysis given below. FOHMY also depends on the network mileage, which changes over the years. This leads one to conclude that FOHMY may not be a very good representation of transmission reliability. In summary, it is observed that a genuine need exists to formulate suitable approaches to evaluate and verify transmission system performance.

### SUMMARY

Systems and methods for assessing reliability of electrical power transmission systems are provided. Embodiments disclosed herein use Outage Impact Index (OII), a new reliability indicator, to identify periodic (e.g., annual) system risks in transmission systems of a bulk power system (BPS) for a given voltage class. OII provides key performance indices which can be used by power utilities to quantify and assess transmission system performance, establish baselines from chronological trends, and minimize system risks by developing corrective measures to address any identified system issues.

An exemplary embodiment provides a method for assessing reliability of an electrical power transmission system. The method includes obtaining information about a number of outages in a specific outage category and power system voltage level during an assessment period; obtaining information about an outage duration associated with each of the number of outages during the assessment period; and determining outage impact for the assessment period as a function of the number of outages and the outage duration for the specific outage category and power system voltage level independent of total outages and total outage duration for the electrical power transmission system.

Another exemplary embodiment provides a method for assessing reliability of an electrical power transmission system. The method includes obtaining a first number of outages in a first set of power system assets during an assessment period, wherein an outage is defined as a failure of at least one of the first set of power system assets; obtaining a first outage duration associated with the first number of outages; and determining a first outage effect for the assessment period as a function of the first number of outages for the first set of power system assets and the first outage duration for the assessment period.

Another exemplary embodiment provides a reliability assessment system. The reliability assessment system includes a database comprising outage information for an electrical power transmission system; and a processing device coupled to the database. The processing device is configured to obtain a number of outages in a set of power system assets of the electrical power transmission system during an assessment period, wherein each outage represents a failure of a power system asset irrespective of a loss of power to a customer; obtain an outage duration for the number of outages during the assessment period; and determine an outage impact for the assessment period as a function of the number of outages for the set of power system assets and the outage duration for the assessment period.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an exemplary power system having transmission lines and substations at multiple voltage levels.

FIG. 2 is a schematic diagram of exemplary states of a power system asset, such as a transmission line, in the power system of FIG. 1.

FIG. 3A is a graphical representation of outage frequency for several voltage levels based on historical outage data.

FIG. 3B is a graphical representation of outage duration for several voltage levels based on the historical outage data.

FIG. 4A is a graphical representation of annual wind-related outage frequency for several voltage levels based on the historical outage data.

FIG. 4B is a graphical representation of annual wind-related outage duration for several voltage levels based on the historical outage data.

FIG. 5A is a graphical representation of annual storm-related outage frequency for several voltage levels based on the historical outage data.

FIG. 5B is a graphical representation of annual storm-related outage duration for several voltage levels based on the historical outage data.

FIG. 6A is a graphical representation of annual lightning-related outage frequency for several voltage levels based on the historical outage data.

FIG. 6B is a graphical representation of annual lightning-related outage duration for several voltage levels based on the historical outage data.

FIG. 7A is a graphical representation comparing traditional reliability metrics of forced outage per hundred miles per year (FOHMY) and total element outage frequency (TOF) based on the historical outage data.

FIG. 7B is a graphical representation comparing traditional reliability metrics of FOHMY and total outage duration (TOD) based on the historical outage data.

FIG. 8 is a graphical representation of sustained and momentary outage frequencies based on the historical outage data.

FIG. 9A is a graphical representation of an annual outage rate (AOR) trend based on the historical outage data.

FIG. 9B is a graphical representation of a TOF trend based on the historical outage data.

FIG. 10A is a graphical representation of an annual outage duration (AOD) trend based on the historical outage data.

FIG. 10B is a graphical representation of a TOD trend based on the historical outage data.

FIG. 11A is a graphical representation of a mean time between failure (MTBF) trend based on the historical outage data.

FIG. 11B is a graphical representation of a mean time to repair (MTTR) trend based on the historical outage data.

FIG. 11C is a graphical representation of Availability based on the historical outage data.

FIG. 12A is a graphical representation summarizing Output Impact Index (OII) per outage category based on the historical outage data.

FIG. 12B is a graphical representation of annual OII values for the outage category Other based on the historical outage data.

FIG. 12C is a graphical representation of annual OII values for the outage category Equipment based on the historical outage data.

FIG. 12D is a graphical representation of annual OII values for the outage category Weather based on the historical outage data.

FIG. 12E is a graphical representation of annual OII values for the outage category External based on the historical outage data.

FIG. 13 is a flow diagram illustrating a process for assessing reliability of an electrical power transmission system.

FIG. 14 is a flow diagram illustrating another process for assessing reliability of an electrical power transmission system.

FIG. 15 is a schematic diagram of a generalized representation of an exemplary computer system that could be used to perform any of the methods or functions described above, such as assessing reliability of an electrical power transmission system.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Systems and methods for assessing reliability of electrical power transmission systems are provided. Embodiments disclosed herein use Outage Impact Index (OII), a new reliability indicator, to identify periodic (e.g., annual) system risks in transmission systems of a bulk power system (BPS) for a given voltage class. OII provides key performance indices which can be used by power utilities to quantify and assess transmission system performance, establish baselines from chronological trends, and minimize system risks by developing corrective measures to address any identified system issues.

I. Transmission System Reliability

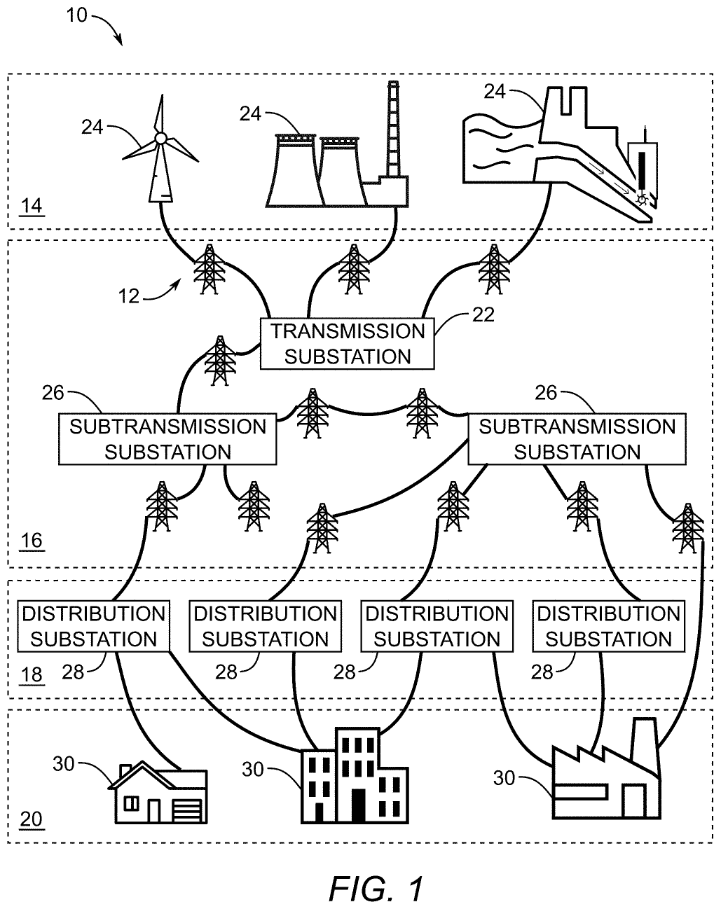

FIG. 1 is a schematic diagram of an exemplary power system 10 having transmission lines 12 and substations at multiple voltage levels. The power system 10 includes one or more of a power generation level 14, a transmission level 16, a distribution level 18, and a load center level 20. Each level of the power system 10 may distribute power at one or more voltage levels.

Voltage levels are stepped up from the power generation level 14 to the transmission level 16. A transmission substation 22 can receive power from one or multiple generating sources 24 in the power generation level 14, and step down or transfer the received power as appropriate. In some embodiments, voltage levels are stepped down from the transmission level 16 to the distribution level 18, and from the distribution level 18 to the load center level 20. This voltage step down is provided through one or more subtransmission substations 26 and/or distribution substations 28. However, voltage levels may vary between different branches of the power system 10. In addition, different load centers 30 may receive different voltage needs, including multiple voltage levels, according to consumption needs.

The ability of the power system 10 to perform its required function within a specified time frame and meet the expected performance criteria is termed as reliability. According to the North American Electric Reliability Corporation (NERC), the definition of reliability of a BPS (e.g., the power system 10) is the ability of the system to withstand disturbances and meet consumer demands consistently. Reliability of the power system 10 ensures secure transfer of uninterrupted power from the generating sources 24 to the load centers 30 and is thus of utmost importance to both utilities and consumers. Unreliability of the power system 10 may lead to cascading failures resulting in brownouts or blackouts.

Reliability of the power system 10 can be measured in terms of frequency, duration, and magnitude of damage caused by transmission line 12 outages. Quantitative evaluation of reliability is a crucial component during planning, design, operation, and maintenance phases of the power system 10. Furthermore, detailed analysis of system reliability may reveal vulnerable areas in the transmission network and establish a chronological system performance that would serve as a guideline for future reliability assessment.

Embodiments described herein introduce OII as a new metric which measures reliability of the transmission network on an annual basis using both outage frequency and duration. This metric can further evaluate severity of transmission line outages on the basis of outage category using historical transmission outage data.

II. Transmission Network Outages

A. State of a Transmission Line

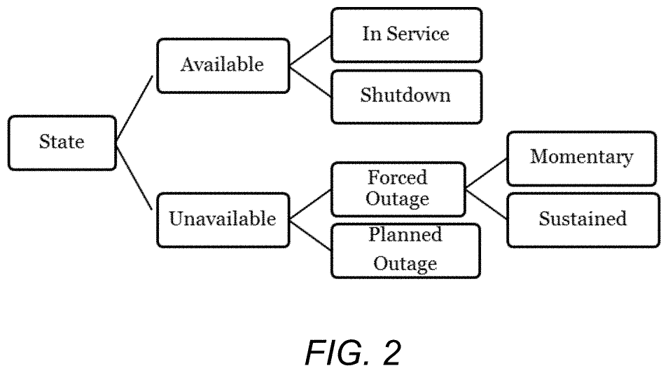

FIG. 2 is a schematic diagram of exemplary states of a power system asset, such as a transmission line, in the power system 10 of FIG. 1. The state of the asset (e.g., transmission line 12 of FIG. 1) refers to whether it is available or unavailable. When the asset is available, it means it is available for operation but can either be in-service or turned off. These decisions are made by the utility operating the power system 10. On the other hand, when the asset is unavailable, it cannot be energized. The asset is either unavailable because of a forced outage or is scheduled for planned maintenance activities. A forced outage occurs against a utility's planning and may occur due to a fault in the power system 10 or as an emergency operating scenario.

Forced outages can be further classified based on duration as:
Momentary Outage: Outage duration of less than 1 minute (usually restored by an auto reclosing/re-energizing of the asset post-fault).
Sustained Outage: Outage duration of 1 minute or longer.
   Both types of forced outages, that is, momentary and sustained, are considered in the analysis which follows.

B. Outage Categories

Power system asset (e.g., transmission line) performance depends on a variety of factors ranging from malfunctioning of power system components to environmental conditions, such as storms. The power industry broadly categorizes transmission outages as: 1) equipment; 2) system protection; 3) lines; 4) weather; 5) lightning; 6) unknown; 7) external; 8) other; and 9) human factors. These categories are further coded into outage subcategories as described in Table 1, and the abbreviations are expanded in Table 2 below.

TABLE 1
Coding of outage categories into outage cause codes

| SI. No. | Outage Category | Outage Cause |
|---|---|---|
| 1 | Equipment | AC, BK, SU, VA |
| 2 | System Protection | CO |
| 3 | Lines | PO, XF |
| 4 | Weather | WI, ST |
| 5 | Lightning | LI |
| 6 | Unknown | UN, KV, FT |
| 7 | External | PC, FS, KV |
| 8 | Other | HU, AN, AU, BI, CN, DE, FI |
| 9 | Human Factors | IP, SP |

TABLE 2
Expansion of outage cause code abbreviations

| Abb. | Description |
|---|---|
| AC | AC Circuit Equipment |
| AN | Animals |
| AU | Vehicle Caused |
| BI | Bird Contact |
| BK | Breaker Failure |
| CN | Contamination |
| CO | Communications, Control, Relay |
| DE | Debris in Equipment |
| FI | Fire |
| FS | Foreign System |
| FT | Fault |
| HU | Inadvertent By Public |
| IP | Inadequate Procedures |
| KV | Underbuilt Line |
| LC | Shunt Capacitor or Reactor Failure |
| LI | Lightning |
| PC | Power System Condition |
| PO | Pole Failure |
| SP | Inadvertent By Utility |
| ST | Storm |
| SU | AC Substation Equipment Failure |
| UN | Unknown |
| VA | Vandalism |
| XF | Transformer Failure |
| WI | Wind |

III. Outage and Reliability Analysis

A. Historical Transmission Outage Data

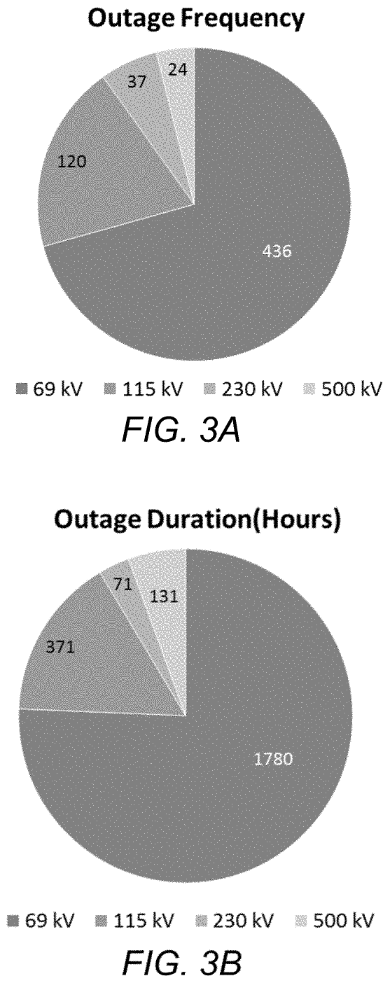

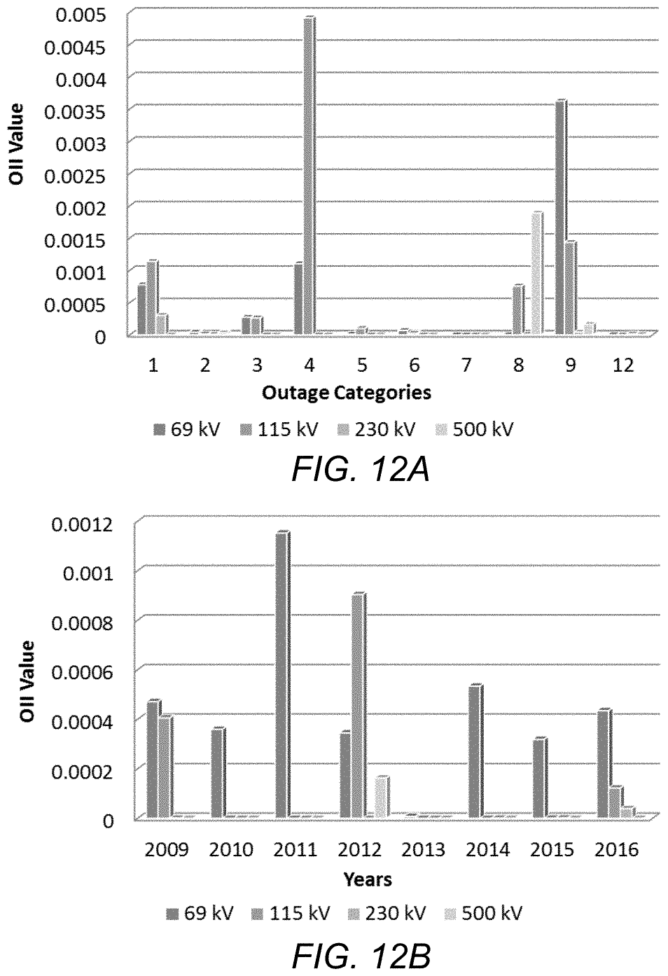

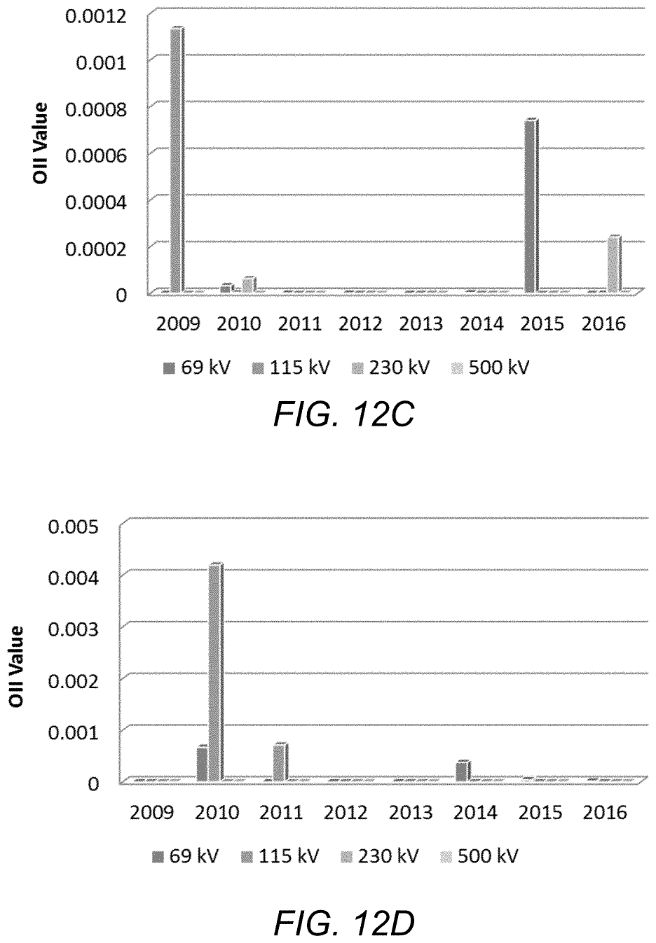

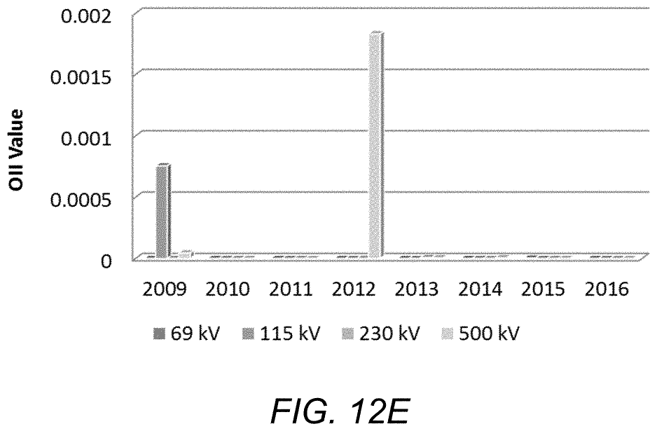

Before discussing specifics of systems and methods providing the novel reliability metric OII, an analysis to compare other approaches to assessing reliability of the exemplary power system 10 of FIG. 1 is discussed. Historical outage data was provided by a US power utility for carrying out this analysis. This historical outage data has been used to analyze outages and assess past system performance, with respect to Section 111.13 below (FIGS. 3A-11C). The same data is used to provide a comprehensive assessment of transmission reliability using OII, with respect to Section III.C below (FIGS. 12A-12E).

In this analysis, the transmission system performance and reliability are evaluated based on the historical forced outage data for the 69-500 kilovolt (kV) voltage levels for the time-period 2009-2016. An inventory of transmission lines (e.g., power system assets) for the utility network is given in Table 3. It is observed that the 69 kV network has the highest number of assets, followed by 230 kV, 115 kV and 500 kV. In terms of mileage, 69 kV lines also have the highest mileage individually.

TABLE 3
Utility transmission inventory

| | Transmission line inventory | | | | |
|---|---|---|---|---|---|
| | 69 kV | 115 kV | 230 kV | 500 kV | Total |
| Line Mileage | 1025 | 264 | 1125 | | 2414 |
| No. of Assets | 296 | 21 | 39 | 18 | 374 |

B. Traditional Approaches to Assessing Reliability

Table 4 lists forced outage per hundred miles per year (FOHMY) trends for the years 2009-2016. It can be observed that, although the FOHMY value for 69 kV lines for 2009 is higher than that of 69 kV lines for 2016, the frequency of outages is identical for the corresponding years. This is due to an increase in line mileage in the year 2016. In this case however, a lower FOHMY value does not indicate that reliability of the 69 kV lines improved in the year 2016. Similarly, for the 115 kV lines, in the year 2015, the FOHMY value is comparable to that of 69 kV lines for the years 2009 and 2016. However, the outage percentage with respect to the total number of lines for 115 kV lines in 2015 was around 71% compared to 20% of 69 kV lines in the corresponding years. Thus, FOHMY alone cannot be used to comprehensively evaluate reliability of the transmission lines.

TABLE 4
FOHMY trends for the years 2009-2016

| FOHMY | 2009 | 2010 | 2011 | 2012 | 2013 | 2014 | 2015 | 2016 |
|---|---|---|---|---|---|---|---|---|
| Mileage | 910.6 | 914.9 | 916.9 | 916.2 | 992.6 | 992.6 | 1024.3 | 1024.3 |
| Frequency | 59 | 60 | 63 | 48 | 32 | 55 | 61 | 59 |
| 69 kV | 6.479 | 6.558 | 6.871 | 5.239 | 3.224 | 5.541 | 5.955 | 5.76 |
| Mileage | 264 | 264 | 264 | 264 | 264 | 264 | 264 | 264.3 |
| Frequency | 19 | 22 | 14 | 14 | 19 | 8 | 15 | 10 |
| 115 kV | 7.197 | 8.333 | 5.303 | 5.303 | 7.197 | 3.03 | 5.682 | 3.784 |
| Mileage | 1015 | 979.6 | 958.1 | 1001.1 | 953.7 | 1004.1 | 1020.1 | 1124.7 |
| Frequency | 4 | 14 | 8 | 9 | 5 | 9 | 7 | 5 |
| 230-500 kV | 0.394 | 1.429 | 0.835 | 0.899 | 0.524 | 0.896 | 0.686 | 0.445 |

FIG. 3A is a graphical representation of outage frequency for several voltage levels based on the historical outage data described above. It can be observed that 69 kV transmission lines have the highest number of outages followed by 115 kV, 230 kV and 500 kV transmission lines.

FIG. 3B is a graphical representation of outage duration for several voltage levels based on the historical outage data. In terms of duration, it can also be observed that 69 kV lines have the maximum duration, followed by 115 kV, 500 kV and 230 kV lines.

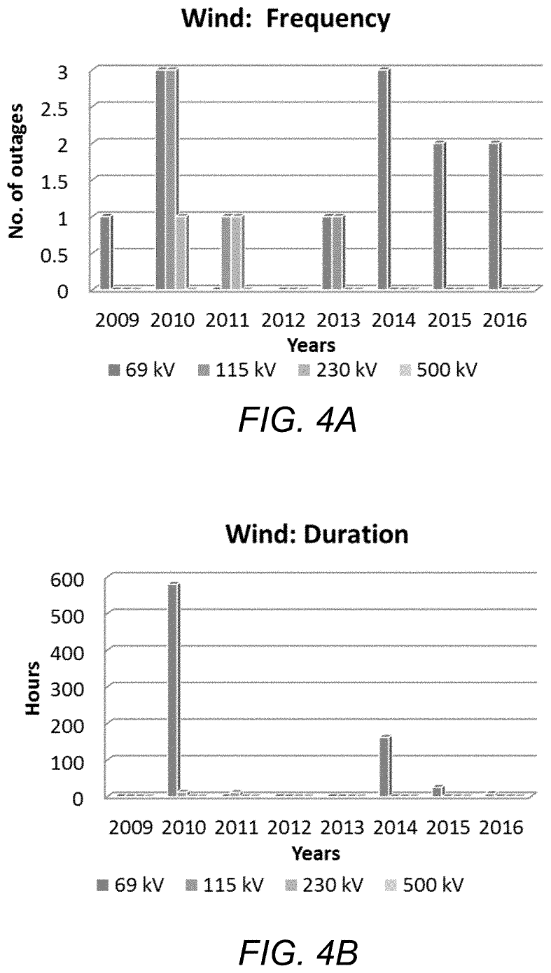

FIG. 4A is a graphical representation of annual wind-related outage frequency for several voltage levels based on the historical outage data. It can be observed that wind-related outages frequencies per year are maximum for 69 kV lines, followed by 115 kV and 230 kV lines. For 500 kV lines, the frequency of wind-related outages is not significant.

FIG. 4B is a graphical representation of annual wind-related outage duration for several voltage levels based on the historical outage data. In terms of outage duration, 69 kV lines have the maximum wind-related outage duration annually, followed by 115 kV lines. For 230 kV and 500 kV lines, the duration of wind-related outages is not significant.

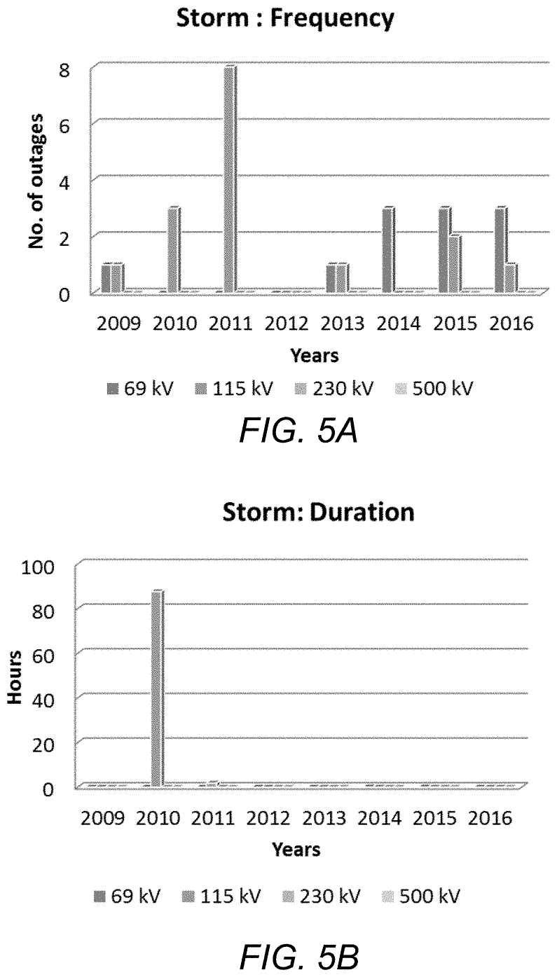

FIG. 5A is a graphical representation of annual storm-related outage frequency for several voltage levels based on the historical outage data. It can be observed that storm-related outage frequencies per year are maximum for 115 kV lines followed by 69 kV lines. For 230 kV and 500 kV lines, the frequency is not significant.

FIG. 5B is a graphical representation of annual storm-related outage duration for several voltage levels based on the historical outage data. In terms of outage duration, 115 kV lines have the maximum storm-related outage duration per year. For 230 kV and 500 kV lines, the duration of storm-related outages is not significant.

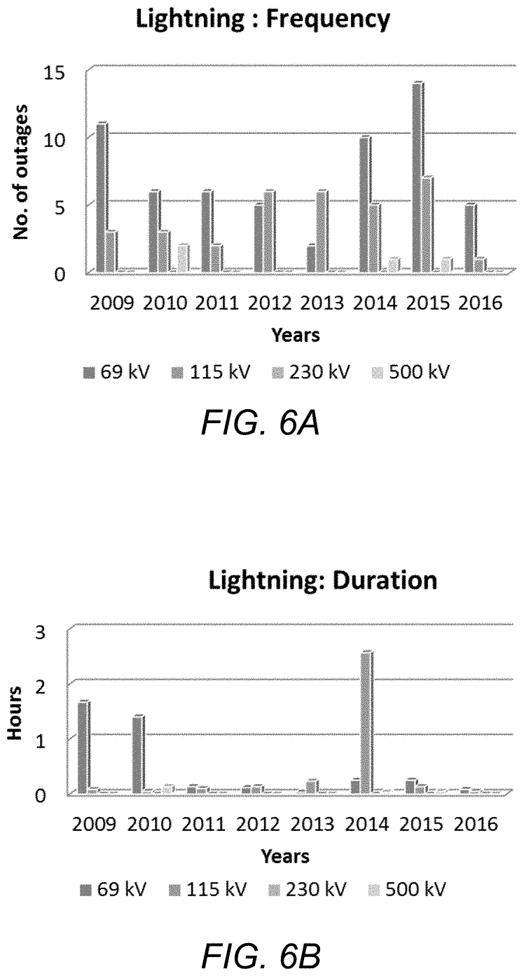

FIG. 6A is a graphical representation of annual lightning-related outage frequency for several voltage levels based on the historical outage data. It can be observed that lightning-related outage frequencies per year are maximum for 69 kV lines followed by 115 kV lines and 500 kV. For 230 kV lines, the frequency is not significant.

FIG. 6B is a graphical representation of annual lightning-related outage duration for several voltage levels based on the historical outage data. In terms of outage duration, 69 kV and 115 kV lines have the maximum lightning-related outage duration per year, followed by 500 kV lines. For 230 kV lines, the lightning-related outage duration is not significant.

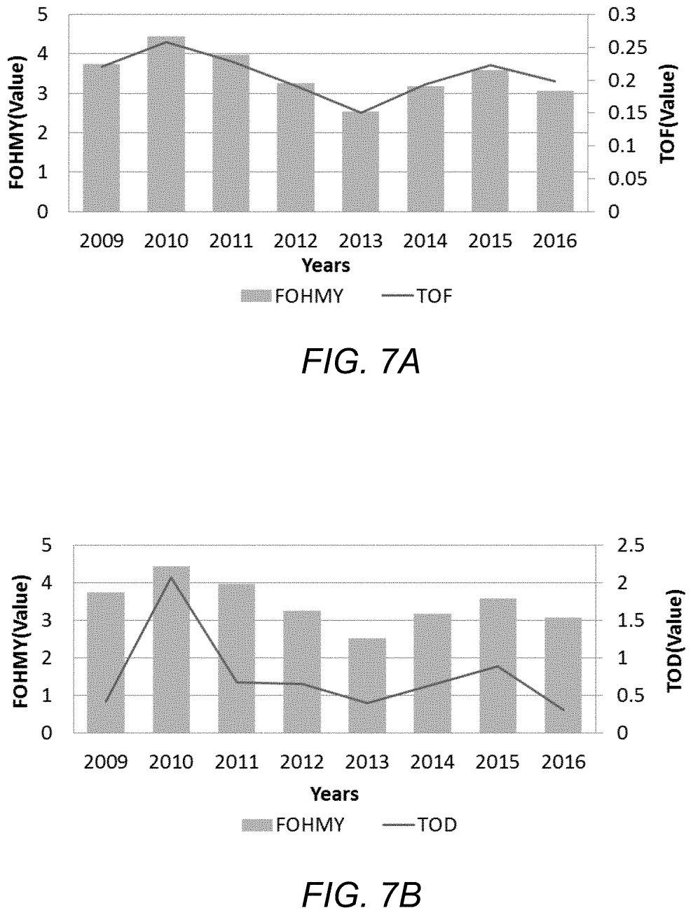

With reference to FIGS. 7A-11C, an outage analysis based on IEEE standards and Transmission Availability Data System (TADS) reliability metrics is described. An outage in the power system 10 of FIG. 1 is detrimental as it can lead to a reduction in transfer path redundancy and/or capacity. Furthermore, the outage duration, which indicates the time for which the line is unavailable, may vary, ranging from less than a minute to several hours. Therefore, while evaluating the performance of the modeled power system using outage data, it is relevant to consider the failure rate, referred to herein as outage frequency, as well as the duration for which the line has been unavailable, referred to herein as outage duration. With respect to FIGS. 7A and 7B, an outage analysis and reliability evaluation of the transmission network performance based on existing indicators described in IEEE standards and TADS is carried out.

In 2008, NERC approved implementation of TADS Phase I which required U.S. transmission owners to report automatic outages beginning in 2008 for AC circuits with voltage levels at or above 200 kV. Some of the reliability metrics developed for reporting transmission outages were:

Outage frequency per 100 Circuit Miles (FOHMY)

Total Element Outage Frequency (TOF)

Total Element Outage Duration (TOD)

Mean Time Between Failure (MTBF)

Mean Time To Repair (MTTR)

Availability

FIG. 7A is a graphical representation comparing traditional reliability metrics of FOHMY and TOF based on the historical outage data. FIG. 7B is a graphical representation comparing traditional reliability metrics of FOHMY and TOD based on the historical outage data. For a preliminary analysis of performance adequacy representation of FOHMY in terms of outage frequency and duration, a comparison between FOHMY and TADS metrics TOF and TOD is made. From FIG. 7A, it is observed that FOHMY and TOF have a positive correlation as both are a representation of the outage frequency. However, from FIG. 7B, it is observed that while the FOHMY value for 2009 was greater than that in 2012, 2014 and 2015, the TOD for 2009 is lower than the TOD values for these three years.

Thus, it can be concluded that FOHMY cannot capture the impact of the outage duration and would therefore not give an accurate representation of transmission line outage severity or reliability in its entirety. This is due to the fact that FOHMY definition is not inclusive of the outage duration. The definitions of TOF and TOD are given below:

TOF is a representation of the outage frequency per transmission element per year and is mathematically defined by:

$$TOF = \frac{Total Outage Frequency}{Total Elements} \qquad Equation 2$$

TOD is a representation of the outage hours per transmission element per year and is mathematically defined by:

$$TOD = \frac{Total Outage Hours}{Total Elements} \qquad Equation 3$$

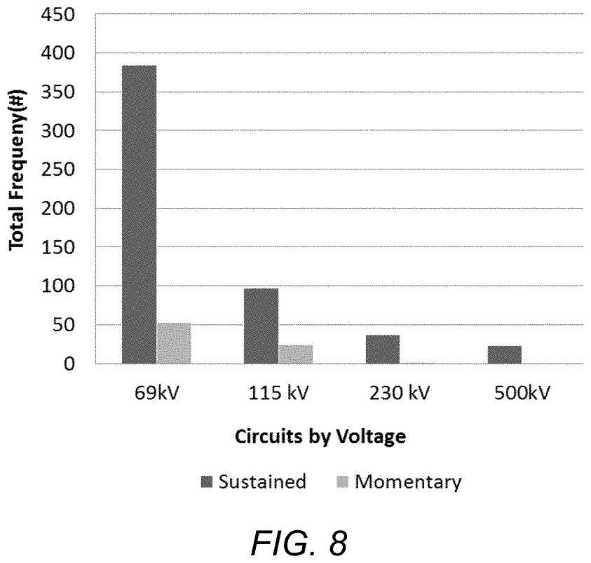

The remaining TADS metrics such as MTBF, MTTR and Availability are described below with respect to FIGS. 8-11C.

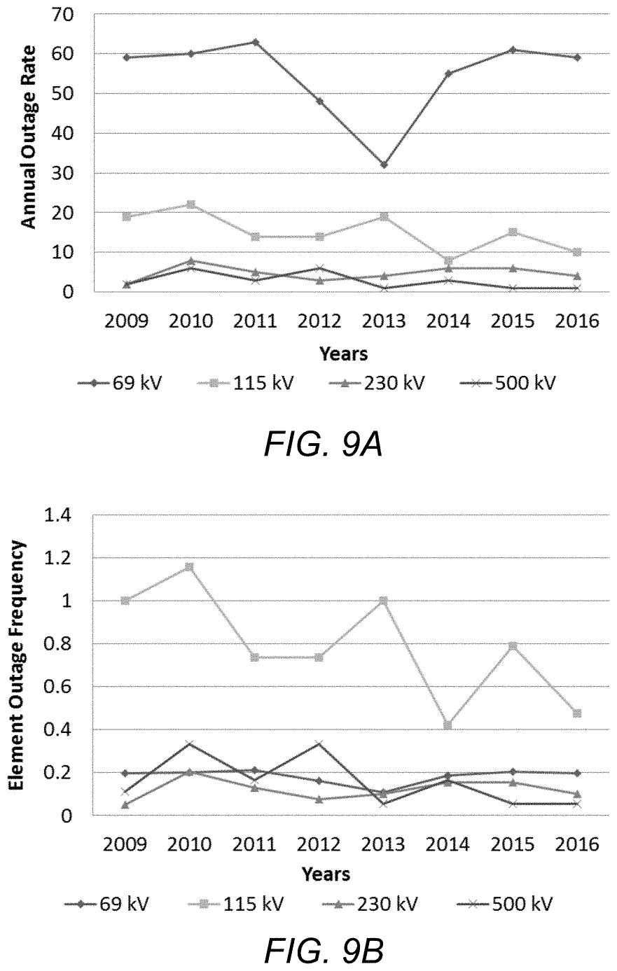

With reference to FIGS. 8, 9A, and 9B, an outage analysis based on outage frequency is described. Forced outages, such as sustained and momentary outages, are considered for this analysis.

FIG. 8 is a graphical representation of sustained and momentary outage frequencies based on the historical outage data. Outages have been analyzed on the basis of frequency of occurrence and have been classified according to their operating voltage level. It is observed that the overall frequency of forced outages is highest for 69 kV, followed by 115 kV, 230 kV, and 500 kV, respectively. It is also observed that the percentage of sustained outages is higher as compared to momentary outages for each voltage level. Frequencies of both momentary and sustained outages are observed to be highest for 69 kV lines followed by the higher voltage rating lines.

FIG. 9A is a graphical representation of an annual outage rate (AOR) trend based on the historical outage data. The AOR provides the annual outage rate of the transmission system specific to a voltage class and is mathematically defined by:

$$AOR = \frac{Total Outage Frequency}{Exposure Time} \qquad Equation 4$$

Exposure time is considered to be 1 year. From FIG. 9A, it is observed that AOR is highest for 69 kV, followed by 115 kV. The AORs of 69 kV are observed to be nearly constant at around 60 outages per year except in 2012-2013, when the rate was observed to have decreased. For 115 kV, the trend is observed to be on a decrease in general except for peaks observed in 2013 and 2015. The AOR value for 115 kV was observed to be around 20 outages or less per year. AOR for 230 kV and 500 kV lines is observed to be in general low at around less than ten outages at an average per year.

FIG. 9B is a graphical representation of a TOF trend based on the historical outage data. TOF, described above with respect to FIG. 7A, depends on the total number of elements in a particular voltage level, so it essentially provides a comparison of the total number of outages as a percentage of the total elements in that particular voltage level. This is helpful in comparing the outage severity for each voltage level with respect to the total number of elements. It is observed that TOF for 69 kV, 230 kV, and 500 kV is lower than that for 115 kV. The TOF for 115 kV is observed to be around 1 in the year 2009 and 2013 but it has been observed to be comparatively lower in the remaining years under study. The TOF for 69 kV, 230 kV, and 500 kV is observed to be lower than 0.4 for the years considered in this analysis.

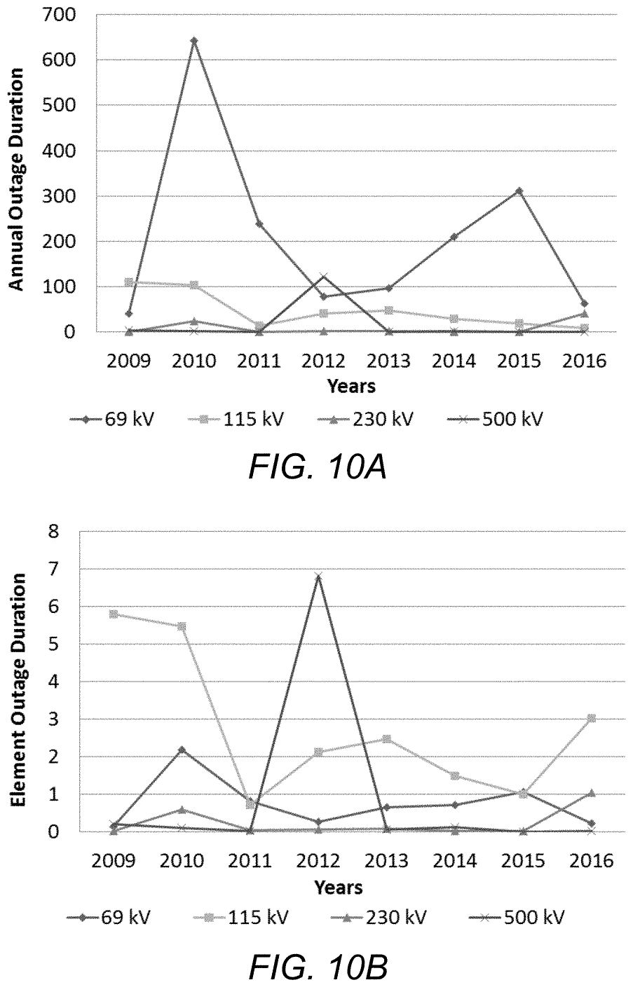

With reference to FIGS. 10A and 10B an outage analysis based on outage duration is described. FIG. 10A is a graphical representation of an annual outage duration (AOD) trend based on the historical outage data. The AOD provides the annual outage duration of the transmission system specific to a voltage class. It is mathematically defined by:

$$AOD = \frac{Total Outage Duration}{Exposure Time} \qquad Equation 5$$

Exposure time is assumed to be 1 year. It is observed that AOD for 69 kV is the highest followed by 115 kV, 230 kV, and 500 kV, respectively. The AOD of 69 kV is also observed to follow a decreasing trend in general except between 2013-2015. For higher voltage levels, the trend is observed to be decreasing in general except for peaks in 2012 (500 kV), 2013 (115 kV) and 2016 (230 kV). In general, over the study period of the historical data, the AOD for the entire 69 kV network is observed to be above 100 hours per year while that for 115 kV is observed to be at an average of 50 hours per year. AOD for 230 kV and 500 kV is observed to be insignificant as compared to 69 kV and 115 kV; however, a peak in AOD is observed for 500 kV lines in the year 2012.

FIG. 10B is a graphical representation of a TOD trend based on the historical outage data. TOD is described above with respect to FIG. 7B. It is observed that TOD is lowest for 500 kV except for the year 2012 and highest for 115 kV, in general. The TOD is the outage hours per transmission element per year and 69 kV values are lower than 115 kV followed by 230 kV. This metric depends on the total number of elements in a particular voltage level, so it essentially provides a comparison of the total outage duration as a ratio of the total elements in that particular voltage level. This is helpful in comparing the outage severity with respect to the total duration for which the element is out for each voltage level. It is observed that TOD for 69 kV, 230 kV, and 500 kV is lower than that for 115 kV. The TOD for 115 kV is observed to be at an average of 2 hours a year except for peaks in 2009 and 2010. The TOF for 69 kV, 230 kV, and 500 kV is observed to be lower than 2 hours throughout the study period. However, a peak in TOD in the year 2012 for the 500 kV lines can be observed.

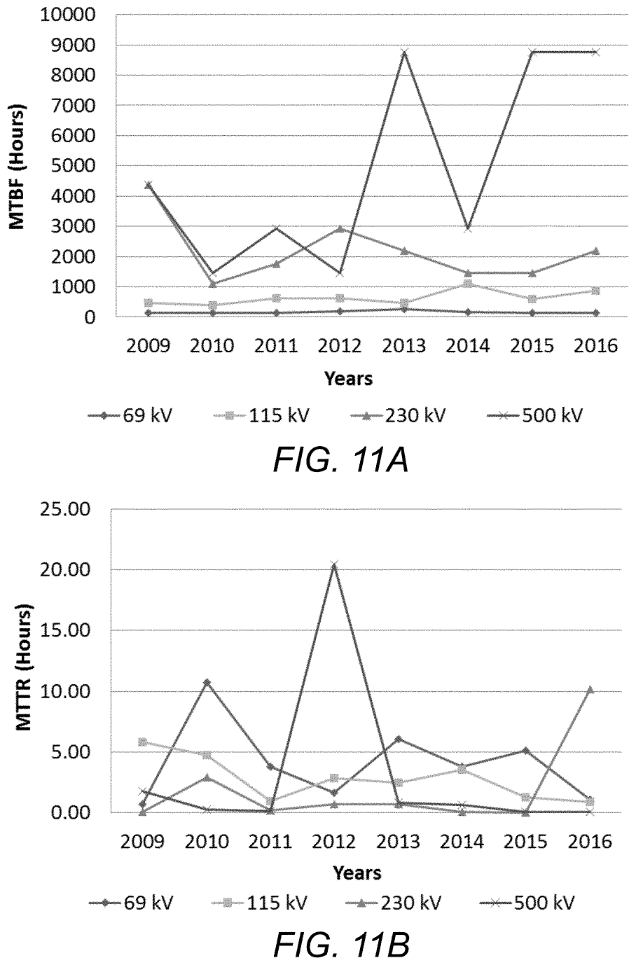

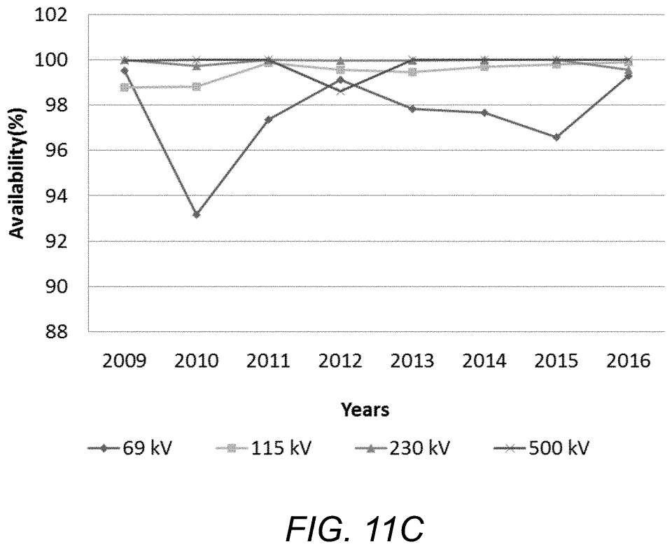

With reference to FIGS. 11A-11C, a reliability analysis based on operation performance is described. Maintainability and availability are parameters used for specification of system design and as indicators of operational performance. They are closely related to and contribute towards system reliability.

FIG. 11A is a graphical representation of a MTBF trend based on the historical outage data. MTBF is a basic measure of the reliability of a system and determines the average time elapsed between two failures. It is denoted by:

$$MTBF = \frac{Exposure Time}{Total Outages} \qquad Equation 6$$

It is observed that MTBF is highest for 500 kV followed by the lower operating voltage lines. Higher values of MTBF are desirable as they indicate a lower number of failures within a specified period. Exposure time is 8760 hours (=1 year).

FIG. 11B is a graphical representation of a MTTR trend based on the historical outage data. MTTR indicates the efficiency of corrective action taken to restore a line that is out and is dependent on a variety of factors, such as human skills, environment, etc. MTTR is denoted by:

$$MTTR = \frac{Outage Duration}{Total Outages} \qquad Equation 7$$

It is observed that MTTR for 69 kV is the highest and it is lower for higher voltages which is desirable as it indicates better maintainability. However, a peak in MTTR was observed for 500 kV in 2012 and for 230 kV in 2016. Low values of MTTR are desired because it indicates efficient repair works.

FIG. 11C is a graphical representation of Availability based on the historical outage data. Availability is a mathematical representation of the percentage of time for which a system is available and ready for use. It is denoted by:

$$Availability = \frac{MTBF}{MTBF + MTTR} \qquad Equation 8$$

It is observed that availability of the transmission lines rated higher than 69 kV is more than 97% throughout the study period. For 69 kV, the availability was observed to be above 97% except for the years 2010 and 2015. Thus, the overall availability of the transmission network under study is very high. Based on the outage analysis and reliability evaluation done above, a chronological trend in outage duration and frequency can be established. This can then become the basis for future reliability assessments.

Table 5 below lists outage categories based on the longest outage duration as well as the maximum/minimum frequency of occurrence. It is observed from Table 5 that the longest outage duration category may not correspond to the most frequently occurring outage category. Hence, focusing only on the number of outages (which is what FOHMY does) would provide information regarding the outage frequency and not the outage duration. As such, it may not be possible to distinguish between two contrasting situations where frequent outages are characterized by lower interrupted durations, as is observed in Table 5 for 69-230 kV lines. To cite an example, for 69 kV lines, it is observed that wind-related outages (WI) are of the longest duration while Debris in Equipment (DE) outages occur most frequently. Therefore, as the most frequent outage type is not necessarily the one that has the longest duration, both frequency and duration should be considered as independent indicators of transmission reliability. This inference becomes the basis of the formulations for Susceptibility Index (SI) and Outage Impact Index (OII), described below with respect to Tables 6-8 and FIGS. 12A-15.

TABLE 5
Outage classification on maximum duration and frequency

| Circuit | Longest | Most | Least |
|---|---|---|---|
| Voltage | Duration | Frequent | Frequent |
| 69 kV | WI | DE | IP, LC, VA* |
| 115 kV | ST | LI | XF, AU, KV* |
| 230 kV | AC | SP, BI* | XF, FT, SU* |
| 500 kV | FS | FS | XF, BK, FT* |

*Multiple entries indicate equal frequency of occurrence

C. Susceptibility Index (SI)

SI, derived from Severity Factor by dropping the term corresponding to loss of load (as this data is not usually recorded for every outage), for an outage category α and voltage level v (e.g., 69, 115, 230 or 500 kV) is given by:

$${SI}_{α , v} = \frac{{N}_{α , v}}{{N}_{v}} * \frac{{IT}_{α , v}}{{IT}_{v}} \qquad Equation 9$$

where N_{α,v} is the number of outages for category α and voltage level v, Nᵥ is the total number of outages for voltage level v, IT_{α,v} is the outage duration for category a and voltage level v. This comprehensive index identifies the most severe outage category by comparing the outage category's (α) frequency and duration to the total outage frequency and duration for the voltage class v.

Table 6 below lists SI values for each outage category and voltage level, where higher values indicate more severe outages. It is observed that 69 kV is most susceptible to the outage category Other, followed by Weather and Equipment. For 115 kV, Weather is the most significant category followed by Other and Equipment. For 230 kV, Equipment is the most significant category followed by Other and Human Factors. For 500 kV, the most significant category is External, followed by Other and System Protection.

TABLE 6
Outage classification based on Susceptibility Index (SI)

| Outage | Outage | | | | |
|---|---|---|---|---|---|
| Category | Cause | 69 kV | 115 kV | 230 kV | 500 kV |
| 1-Equipment | AC, BK, | 0.0080 | 0.0097 | 0.0764 | 2.21E−05 |
| | SU, VA | | | | |
| 2-System | CO | 0.0003 | 0.0033 | 0.0030 | 0.0050 |
| Protection | | | | | |
| 3-Lines | PO, XF | 0.0034 | 0.0030 | 0 | 0 |
| 4-Weather | WI, ST | 0.0221 | 0.0542 | 0.0001 | 0 |
| 5-Lightning | LI | 0.0002 | 0.0025 | 0 | 0.0003 |
| 6-Unknown | UN, KV, | 0.0010 | 0.0007 | 2.61E−05 | 2.76E−05 |
| | FT | | | | |
| 8-External | PC, FS, | 7.11E−05 | 0.0047 | 0.0022 | 0.2359 |
| | KV | | | | |
| 9-Other | HU, AN, | 0.0963 | 0.0364 | 0.0603 | 0.0085 |
| | AU, BI, | | | | |
| | CN, DE, | | | | |
| | FI | | | | |
| 12-Human | IP, SP | 3.40E−05 | 3.45E−05 | 0.0041 | 0.0008 |
| Factors | | | | | |

Table 7 provides a comparison of annual SI for 500 kV lines for the years 2009 and 2012 for outage category External (8). While SI is useful in identifying the severity of outage categories specific to a voltage class, it is not useful for comparing outage severity across different years. For example, in Table 7 it is observed that although the frequency and duration of outages for the year 2009 was lower than that in 2012, the respective SI values for 2009 (1) and 2012 (0.3929) are not indicative of the severity of the outages in terms of outage duration or frequency. This is because SI is a relative frequency and duration product, and it calculates the severity specific to a year, outage category α and voltage level v. It cannot be used for comparing the severity of outages across different years because the severity is not compared with a common base. The base depends on Nᵥ and IT_{α,v}, which vary according to the year of study and the outage category. Thus, SI values, and by extension, Severity Factor, for an outage category are not comparable when calculated annually.

TABLE 7
Comparison of Annual Susceptibility Index (SI) for 2009 and 2012

| | 2009 | 2012 | 2009 | 2012 | 2009 | 2012 |
|---|---|---|---|---|---|---|
| 500 kV | Frequency (#) | | Duration (mins) | | SI | |
| 1-Equipment | 0 | 0 | 0 | 0 | 0 | 0 |
| 2-System | 0 | 1 | 0 | 8 | 0 | 0.0002 |
| Protection | | | | | | |
| 3-Lines | 0 | 0 | 0 | 0 | 0 | 0 |
| 4-Weather | 0 | 0 | 0 | 0 | 0 | 0 |
| 5-Lightning | 0 | 0 | 0 | 0 | 0 | 0 |
| 6-Unknown | 0 | 0 | 0 | 0 | 0 | 0 |
| 8-External | 2 | 3 | 214 | 5778 | 1 | 0.3929 |
| 9-Other | 0 | 1 | 0 | 1543 | 0 | 0.0349 |
| 12-Human | 0 | 1 | 0 | 24 | 0 | 0.0005 |
| Factors | | | | | | |
| Total | 2 | 6 | 214 | 7353 | | |

D. Outage Impact Index (OII)

With reference to Table 8 and FIGS. 12A-15, to overcome the shortcomings of SI and other approaches described above, embodiments of the present disclosure provide the novel index OII for analyzing reliability of the power system 10 of FIG. 1. OII allows comparison of outage severity in terms of power system asset outage frequency (e.g., the outage frequency for an outage category a and voltage level v) as a fraction of the total number of assets for the voltage level v, and the downtime severity, where downtime may be expressed as a fraction of an annual service period. These ratios would serve as a common base for analyzing transmission outage severity according to outage category and voltage class. Thus, this index can be calculated annually and would allow comparison of outage severity across different years.

The proposed index, OII, is mathematically defined by

$${OII}_{α , v} = \frac{{N}_{α , v}}{{T}_{v}} * \frac{{IT}_{α , v}}{{ET}_{v}} \qquad Equation 10$$

OII_{α,v} is the outage impact index for category α and voltage level v. N_{α,v} is the number of outages for category α and voltage level v. Tᵥ is the total number of power system assets having voltage level v. IT_{α,v} is the outage duration for category α and voltage level v. ETᵥ is the exposure time for an assessment period (e.g., one year=8,760 hours, one month, or another period of time as appropriate, such as a user-definable assessment period).

It should be understood that OII is used to measure outages of any one or more assets of an electrical power transmission system, such as a transmission line, circuit breaker, transformer, reactor, or other circuit or structure. It should be further understood that an outage as measured by OII is defined as a failure of any one or more of these assets, irrespective of any loss of failure to a customer (e.g., a load center 30 in FIG. 1). The OII therefore provides an objective measure of equipment health in the electrical power transmission system.

Table 8 presents corresponding OII values for the example described in Table 7. It is observed from Table 8 that OII gives an accurate representation of outage severity for years 2009 (4.52E-05) and 2012 (0.0018) in contrast to SI values of 1 and 0.39 for the same years (obtained in Table 7). Accordingly, outage severity for the outage category External (8) is higher for the year 2012 as compared to the year 2009. This index makes it possible to compare severity for each category on an annual basis, unlike SI or Severity Factor.

TABLE 8
Outage classification on maximum duration and frequency

| | 2009 | 2012 | 2009 | 2012 | 2009 | 2012 |
|---|---|---|---|---|---|---|
| 500 kV | Frequency (#) | | Duration (mins) | | OII | |
| 1-Equipment | 0 | 0 | 0 | 0 | 0 | 0 |
| 2-System | 0 | 1 | 0 | 8 | 0 | 8.45E−07 |
| Protection | | | | | | |
| 3-Lines | 0 | 0 | 0 | 0 | 0 | 0 |
| 4-Weather | 0 | 0 | 0 | 0 | 0 | 0 |
| 5-Lightning | 0 | 0 | 0 | 0 | 0 | 0 |
| 6-Unknown | 0 | 0 | 0 | 0 | 0 | 0 |
| 8-External | 2 | 3 | 214 | 5778 | 4.52E−05 | 0.0018 |
| 9-Other | 0 | 1 | 0 | 1543 | 0 | 0.0002 |
| 12-Human | 0 | 1 | 0 | 24 | 0 | 2.52E−06 |
| Factors | | | | | | |
| Total | 2 | 6 | 214 | 7353 | | |

E. Analysis of OII

FIG. 12A is a graphical representation summarizing OII per outage category based on the historical outage data. This presents the outage severity for the years 2009-2016, in which it is observed that overall severity for categories Other (9), Weather (4), External (8), and Equipment (1) are high. Annual investigation of the outage categories would therefore reveal potential risks in terms of both outage downtime and frequency.

FIG. 12B is a graphical representation of annual OII values for the outage category Other (9) based on the historical outage data. It is observed that outage severity for this category is in general high with an average value of 0.0004 for 69 kV followed by 115 kV lines. Similarly, all outage categories can be prioritized based on their duration and frequency severity for further investigation as depicted in FIGS. 12C-12E.

FIG. 12C is a graphical representation of annual OII values for the outage category Equipment (1) based on the historical outage data.

FIG. 12D is a graphical representation of annual OII values for the outage category Weather (4) based on the historical outage data.

FIG. 12E is a graphical representation of annual OII values for the outage category External (8) based on the historical outage data.

Finally, corrective action such as operation practices, maintenance strategies, and spare management can be developed based on the analysis results. It is important to mention here that identification and prioritization of outages based on frequency and duration as has been done above is not possible with FOHMY.

The impact of transmission line outages in terms of load lost (in megawatts (MW)) can also be incorporated in the definition of OII, if that information is available. This can be included in the form of a ratio in terms of the total rated capacity of the line. Based on the severity of outages categories identified by OII, further reliability and root-cause analysis may need to be carried out to identify potential system risks and take corrective action.

IV. Process for Assessing Reliability (Using OII)

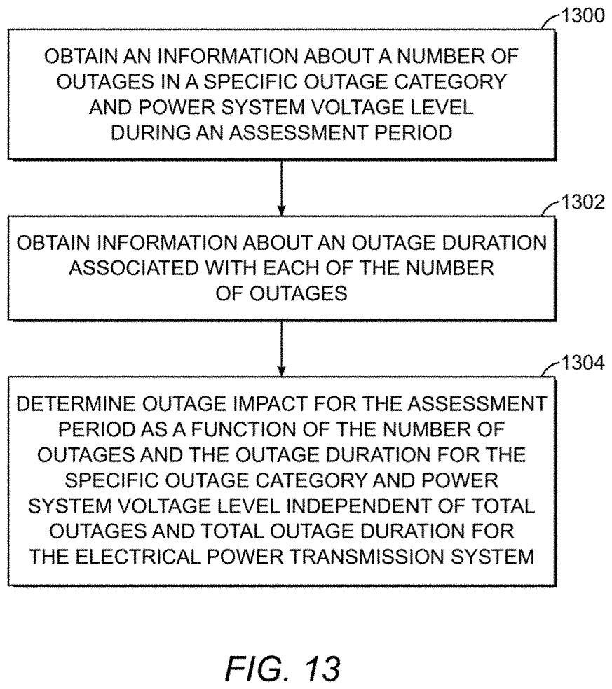

FIG. 13 is a flow diagram illustrating a process for assessing reliability of an electrical power transmission system. The process begins at operation 1300, with obtaining information about a number of outages in a specific outage category and power system voltage level during an assessment period. The process continues at operation 1302, with obtaining information about an outage duration associated with each of the number of outages. The process continues at operation 1304, with determining outage impact for the assessment period as a function of the number of outages and the outage duration for the specific outage category and power system voltage level independent of total outages and total outage duration for the electrical power transmission system.

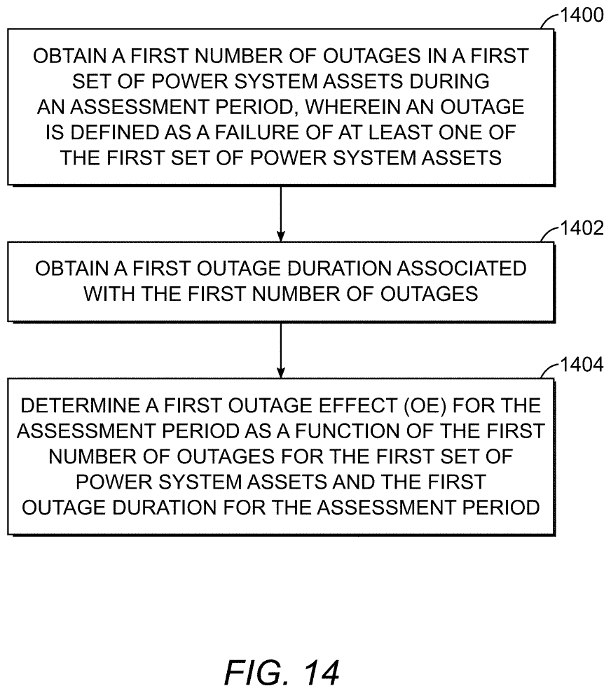

FIG. 14 is a flow diagram illustrating another process for assessing reliability of an electrical power transmission system. The process begins at operation 1400, with obtaining a first number of outages in a first set of power system assets during an assessment period, wherein an outage is defined as a failure of at least one of the first set of power system assets. The process continues at operation 1402, with obtaining a first outage duration associated with the first number of outages. The process continues at operation 1404, with determining a first outage effect (OE) for the assessment period as a function of the first number of outages for the first set of power system assets and the first outage duration for the assessment period.

In an exemplary aspect, the outage effect of FIG. 14 is similar to the OII, but may provide an objective measure of transmission system reliability on the whole (e.g., as a composite score), or of a particular portion of the transmission system. For example, an outage effect may measure a single outage category at a single voltage level, rather than provide a complete index.

The outage effect may be mathematically defined by

$$O E = \frac{N}{T} * \frac{IT}{E T} \qquad Equation 11$$

OE is the outage effect (which may be for one or multiple outage categories and one or more voltage levels). N is the number of outages. T is the number of power system assets being measured. IT is the outage duration for the assets being measured. ET is the exposure time for an assessment period (e.g., one year=8,760 hours, one month, or another period of time as appropriate, such as a user-definable assessment period). In some examples, multiple outage effects may be amalgamated to provide the OII as defined in Equation 10.

Although the operations of FIGS. 13 and 14 are illustrated in a series, this is for illustrative purposes and the operations are not necessarily order dependent. Some operations may be performed in a different order than that presented. Further, processes within the scope of this disclosure may include fewer or more steps than those illustrated in FIGS. 13 and 14.

V. Computer System

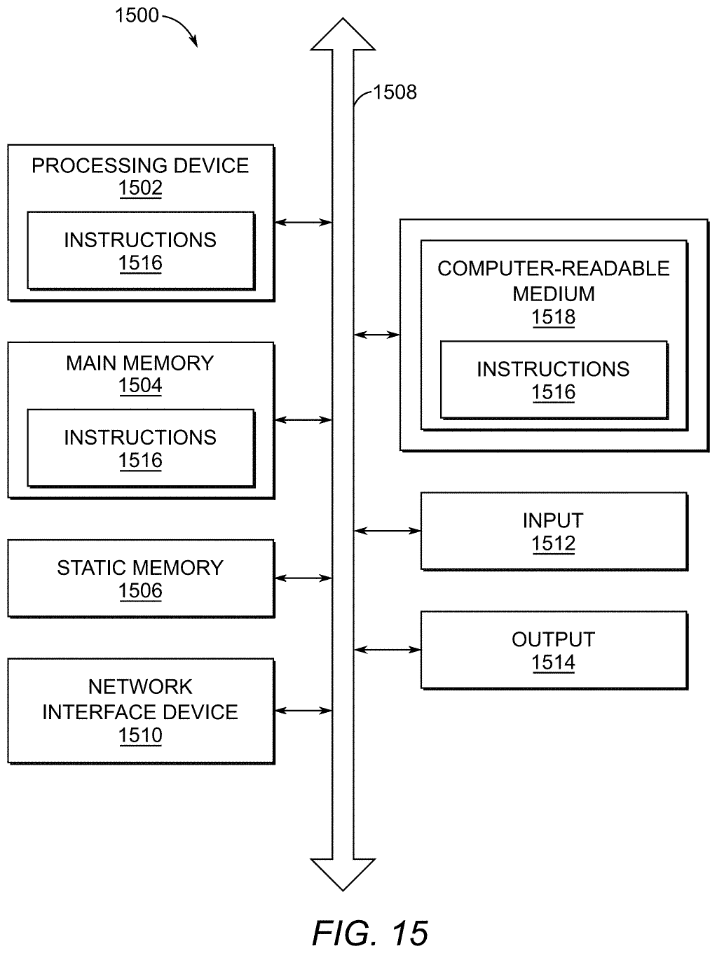

FIG. 15 is a schematic diagram of a generalized representation of an exemplary computer system 1500 that could be used to perform any of the methods or functions described above, such as assessing reliability of an electrical power transmission system. In this regard, the computer system 1500 may be a circuit or circuits included in an electronic board card, such as, a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 1500 in this embodiment includes a processing device 1502 or processor, a main memory 1504 (e.g., read-only memory (ROM), flash memory, dynamic random access memory (DRAM), such as synchronous DRAM (SDRAM), etc.), and a static memory 1506 (e.g., flash memory, static random access memory (SRAM), etc.), which may communicate with each other via a data bus 1508. Alternatively, the processing device 1502 may be connected to the main memory 1504 and/or static memory 1506 directly or via some other connectivity means. In an exemplary aspect, the processing device 1502 could be used to perform any of the methods or functions described above.

The processing device 1502 represents one or more general-purpose processing devices, such as a microprocessor, central processing unit (CPU), or the like. More particularly, the processing device 1502 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 1502 is configured to execute processing logic in instructions for performing the operations and steps discussed herein.

The various illustrative logical blocks, modules, and circuits described in connection with the embodiments disclosed herein may be implemented or performed with the processing device 1502, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 1502 may be a microprocessor, or may be any conventional processor, controller, microcontroller, or state machine. The processing device 1502 may also be implemented as a combination of computing devices (e.g., a combination of a DSP and a microprocessor, a plurality of microprocessors, one or more microprocessors in conjunction with a DSP core, or any other such configuration).

The computer system 1500 may further include a network interface device 1510. The computer system 1500 also may or may not include an input 1512, configured to receive input and selections to be communicated to the computer system 1500 when executing instructions. The input 1512 may include, but not be limited to, a touch sensor (e.g., a touch display), an alphanumeric input device (e.g., a keyboard), and/or a cursor control device (e.g., a mouse). The computer system 1500 also may or may not include an output 1514, including but not limited to a display, a video display unit (e.g., a liquid crystal display (LCD) or a cathode ray tube (CRT)), or a printer. In some examples, some or all inputs 1512 and outputs 1514 may be combination input/output devices.

The computer system 1500 may or may not include a data storage device that includes instructions 1516 stored in a computer-readable medium 1518. The instructions 1516 may also reside, completely or at least partially, within the main memory 1504 and/or within the processing device 1502 during execution thereof by the computer system 1500, the main memory 1504, and the processing device 1502 also constituting computer-readable medium. The instructions 1516 may further be transmitted or received via the network interface device 1510.

While the computer-readable medium 1518 is shown in an exemplary embodiment to be a single medium, the term “computer-readable medium” should be taken to include a single medium or multiple media (e.g., a centralized or distributed database, and/or associated caches and servers) that store the one or more sets of instructions 1516. The term “computer-readable medium” shall also be taken to include any medium that is capable of storing, encoding, or carrying a set of instructions for execution by the processing device 1502 and that causes the processing device 1502 to perform any one or more of the methodologies of the embodiments disclosed herein. The term “computer-readable medium” shall accordingly be taken to include, but not be limited to, solid-state memories, optical medium, and magnetic medium.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A method for assessing reliability of an electrical power transmission system, the method comprising:
obtaining information about a number of outages in a specific outage category and power system voltage level during an assessment period;
obtaining information about an outage duration associated with each of the number of outages during the assessment period; and
determining outage impact for the assessment period as a function of the number of outages and the outage duration for the specific outage category and power system voltage level independent of total outages and total outage duration for the electrical power transmission system.

2. The method of claim 1, wherein the outage impact is further a function of the number of outages over a number of power system assets.

3. The method of claim 1, wherein the outage impact is further a function of the outage duration over the assessment period.

4. The method of claim 1, wherein determining the outage impact is performed according to a formula given by:
$${OII}_{α , v} = \frac{{N}_{α , v}}{{T}_{v}} * \frac{{IT}_{α , v}}{{ET}_{v}}$$
where α is the specific outage category, v is the power system voltage level, OII_{α,v} is the outage impact defined as an outage impact index, N_{α,v} is the number of outages for the specific outage category and the power system voltage level, Tᵥ is a total number of power system assets in the power system voltage level, IT_{α,v} is the outage duration for the specific outage category and the power system voltage level, and ETᵥ is the assessment period.

5. The method of claim 4, wherein the outage impact index provides a measure of equipment health in the electrical power transmission system.

6. The method of claim 4, wherein the assessment period comprises at least one year.

7. The method of claim 1, wherein each of the number of outages represents a failure of one or more power system assets in the electrical power transmission system.

8. The method of claim 7, wherein the failure of the one or more power system assets is considered an outage irrespective of a loss of power to a customer of the electrical power transmission system.

9. A method for assessing reliability of an electrical power transmission system, the method comprising:
obtaining a first number of outages in a first set of power system assets during an assessment period, wherein an outage is defined as a failure of at least one of the first set of power system assets;
obtaining a first outage duration associated with the first number of outages; and
determining a first outage effect for the assessment period as a function of the first number of outages for the first set of power system assets and the first outage duration for the assessment period.

10. The method of claim 9, wherein determining the first outage effect for the assessment period is performed according to a formula given by:
$$OE = \frac{N}{T} * \frac{IT}{ET}$$
where OE is the first outage effect, N is the first number of outages, T is a number of power system assets in the first set of power system assets, IT is the first outage duration, and ET is the assessment period.

11. The method of claim 9, wherein the first set of power system assets comprises power system assets in the electrical power transmission system having a first voltage level and a first outage category.

12. The method of claim 11, wherein the first outage duration is a total outage duration for the first number of outages of the first set of power system assets in the electrical power transmission system having the first voltage level and the first outage category.

13. The method of claim 11, further comprising, for each of a plurality of voltage levels and each of a plurality of outage categories:
obtaining a respective number of outages in a respective set of power system assets having a given voltage level of the plurality of voltage levels and a given outage category of the plurality of outage categories during the assessment period;
obtaining a respective outage duration associated with the respective number of outages; and
determining a respective outage effect for the assessment period as a function of the respective number of outages for the respective set of power system assets and the respective outage duration for the assessment period.

14. The method of claim 13, further comprising determining an outage impact index, comprising the first outage effect and each of the respective outage effects for each of the plurality of voltage levels and each of the plurality of outage categories.

15. The method of claim 14, wherein determining the outage impact index is performed according to a formula given by:
$${OII}_{α , v} = \frac{{N}_{α , v}}{{T}_{v}} * \frac{{IT}_{α , v}}{{ET}_{v}}$$
where α is the given outage category, v is the given voltage level, OII_{α,v} is the outage impact index, N_{α,v} is the respective number of outages for the given outage category and the given voltage level, Tᵥ is a total number of power system assets having the first voltage level, IT_{α,v} is the respective outage duration for the given outage category and the given voltage level, and ETᵥ is the assessment period.

16. The method of claim 10, wherein the assessment period is one year.

17. The method of claim 10, wherein the assessment period is one month.

18. The method of claim 10, wherein the assessment period is user-definable.

19. A reliability assessment system, comprising:
a database comprising outage information for an electrical power transmission system; and
a processing device coupled to the database and configured to:
obtain a number of outages in a set of power system assets of the electrical power transmission system during an assessment period, wherein each outage represents a failure of a power system asset irrespective of a loss of power to a customer;
obtain an outage duration for the number of outages during the assessment period; and
determine an outage impact for the assessment period as a function of the number of outages for the set of power system assets and the outage duration for the assessment period.

20. The reliability assessment system of claim 19, wherein the outage impact is further a function of the number of outages over the number of power system assets and the outage duration over the assessment period.
